(19) United States
(12) Patent Application Publication
(10) Pub. No.: US 2015/0362124 A1
(43) Pub. Date: Dec. 17, 2015

(54) DEVICE FOR STORING AND RESTORING FLUIDS AT A NEAR-CONSTANT HIGH PRESSURE

(71) Applicant: FIVES, Paris (FR)

(72) Inventors: Claude FAVY, Faucon de Barcelonnette (FR); Sebastien DEVROE, Hellemmes (FR)

(21) Appl. No.: 14/761,469

(22) PCT Filed: Jan. 14, 2014
(86) PCT No.: PCT/FR2014/050064

§ 371 Date: Jul. 16, 2015

(30) Foreign Application Priority Data
Jan. 17, 2013 (FR) 13 50405

(51) Int. Cl. F17C 1/00

(52) U.S. Cl. CPC F17C 1/00; F17C 2201/0138

(57) ABSTRACT

Device for storing and releasing fluids at nearly constant pressure, the fluids including a gas and a liquid, includes an assembly of substantially identical reservoirs (1), where the reservoirs include: a portion containing the gas (G) and a portion containing the liquid (L), an element (23) of separation between the gas and the liquid in the reservoir (1), an inlet orifice (36) and an outlet orifice (36) for the gas, an inlet orifice (35) and an outlet orifice (35) for the liquid. The reservoirs (1) have a cylindrical outer envelope (100) made up of at least one metal tube (101) of the type of those used for gas pipelines and oil pipelines, for which: the external diameter is more than 32 inches (813 mm); and the ratio of the length thereof to the outer diameter thereof is greater than 8.

The present invention relates to a device for storing a compressed gas intended for use for an industrial process or for driving a turbine in order to produce electricity.

In our days, the use of compressed gas and more specifically compressed air represents a major component in most industrial sectors. Without being exhaustive, the aeronautic, spatial, food and agriculture, automobile, chemistry, metallurgy, glassmaking, oil or even glass sectors can be listed. All by itself the production of compressed air represents 10% of industrial electricity consumption.

Storage of a large capacity of these gases at the pressures commonly used in the industry, which range from six up to several tens of bars, is rarely used considering the low storage densities and the variable release pressures.

At this time, large capacity gas storage facilities use natural or artificial underground cavities.

Underground cavities require a specific geological context of sealing, pressure allowed by the surrounding rock and seismic risk. The possibilities for establishing sites are therefore limited and do not necessarily correspond to locations where electrical energy storage is desirable, for example because of their remoteness from consumption or production sites or insufficient electrical grid in these areas.

One of the major disadvantages of these installations is that they do not serve to maintain a constant pressure during air storage and release operations.

This then requires either a compression facility capable of operating at a variable outlet pressure, a gas expansion facility which can operate at a variable inlet pressure and the use of stored air limited to a pressure interval corresponding to the pressure interval in which the compression and expansion facilities can operate, or regulating the outlet pressure from the storage to a minimum value of the operating interval of the storage. These pressure variations have a major influence on the yield of the facility and on the usable compressed air storage capacity. As an example, the Huntorf facility in Germany uses a 310,000 m³ underground storage in the 43 to 70 bar pressure range. The Macintosh facility in the US uses a 370,000 m³ underground storage in the 45 to 80 bar pressure range. It can be noted that the maximum pressures, considering the stability constraints of the underground cavities is limited to 80 bars and that the usable pressure interval is about 40 bars. These two factors considerably limit the energy which can be stored per unit volume of the reservoir.

In the U.S. Pat. No. 4,355,923 a concept was proposed, in the context of an underground cavity, making it possible to obtain a constant pressure because of the connection of the cavity with a hydraulic reservoir at a higher location. This concept requires both very specific geological conditions and a limitation of the pressure in the reservoir to the hydrostatic pressure generated by the hydraulic reservoir.

More recently, two concepts for subsea gas storage were proposed: one calls for a deformable subsea reservoir, as in U.S. Pat. No. 6,863,474 B2, and the other for a rigid subsea reservoir, as in U.S. Pat. No. 7,735,406 B2, with which to maintain the pressure of the gas at the hydrostatic pressure at the depth where the storage is installed. The fact that a constant pressure can be maintained during gas storage and release operations constitutes a major advantage of these concepts. However, because it involves subsea facilities at great depth, it is clear that they will be complex and costly to implement and operate.

These two concepts also have the disadvantage of only being able to operate at a pressure corresponding to the hydrostatic pressure at the depth where the storage is installed.

Hence, it appears that for a given reservoir type, there is an economic interest in storing the gas at the maximum pressure compatible with both the mechanical constraints in the material making up the reservoir and with the maximum thicknesses that can be technically implemented. There is therefore a major interest in being able to choose the pressure in the storage independent of the external environment.

The reservoir must be able to resist the largest possible stresses, due in particular to the pressure of the stored gas. However, it must also have a minimal bulk in order to be easily placed, for example, on an industrial worksite.

The device according to the invention will serve to provide a response to these difficulties. In particular:
It serves to store and release a gas contained in a rigid enclosure at a nearly-constant very high pressure because of a liquid, where this pressure can be chosen independently of the pressure conditions in the environment of the storage, in particular the hydrostatic pressure in the case of underwater storage;
The storage portion of the device can be installed on ground without requiring a specific geological or topographic context or underwater, which makes possible to take advantage of the hydrostatic pressure at the storage level both in terms of resistance of the enclosure and pumping pressures and in terms of reduced hydraulic spinning;
It serves to limit the bulk while retaining an optimal stored volume.

Additionally:
The device serves to seal the gas against liquid in order to maintain the gas at a nearly constant pressure;
Advantageously the storage portion can be installed both in a vertical or horizontal position and even in an inclined position;
The effect of leaks from the storage portion that would result in sealing defects of the gas/liquid separation system can be limited.

Additionally:
The device can be used to provide low-cost gas storage for industrial gas use at a pressure below the storage pressure;
The device can advantageously be set up directly on an industrial site in order to take advantage of the site's facilities and also in order to provide facilities for the site.

For this purpose, the invention also relates to a device for storing and releasing fluids at nearly constant pressure, said fluids including a gas and a liquid, comprising an assembly of substantially identical reservoirs, where said reservoirs include:
a first portion containing the gas and a second portion containing the liquid;
a means of separation between the gas and the liquid in the reservoir;
an inlet orifice and an outlet orifice for the gas opening into the portion of the reservoir containing the gas;
an inlet orifice and an outlet orifice for the liquid opening into the portion of the reservoir containing the liquid;
   wherein the reservoirs have a cylindrical outer envelope made up of at least one metal tube of the type of those used for gas pipelines and oil pipelines, for which:
the external diameter is more than 32 inches (813 mm);
the ratio of the length thereof to the outer diameter thereof is greater than 8.

Preferably, the diameter of the metal tube is equal to 48 inches (1219 mm) or 56 inches (1422 mm).

Advantageously, the tube results from shaping and welding a flat rolled metal strip.

In order to limit the number of reservoirs for a given storage capacity, the outer cylindrical envelope includes a plurality of metal tubes welded end to end.

The device thus has many possibilities for use, for storing and releasing a gas at a fixed pressure, and has many applications in the domains of energy and of any industrial process using a compressed gas.

Preferably, the device includes means of separation between the gas and the liquid in the fluid storage reservoir, so as to avoid mixing between the gas and the liquid.

According to an embodiment, the means of separation comprise a deformable membrane floating on the surface of the liquid.

According to another embodiment, the means of separation comprise a membrane deformable under pressure in the fluid storage reservoir in order to accompany variations of volume of the portion containing the liquid and the portion containing the gas.

This other embodiment breaks down into two main variants:
The membrane constitutes a thickness of material placed between the liquid and the gas. It is attached to the reservoir over the entirety of the periphery thereof.
The membrane constitutes a bladder, or casing, which can without preference contain the gas or the liquid.

In the case of a bladder, it can advantageously be contained in an internal envelope which can for example be a simple metal grate or an expanded pierced or perforated metal wall. This inner envelope serves to delimit the volume which can be occupied by the deformable membrane, and/or to maintain the membrane in a defined position in the reservoir and/or to avoid having the membrane rub directly against the wall of the reservoir.

According to another example, the invention proposes that the means of separation between the gas and the liquid comprise a rigid and mobile diaphragm defining a separation surface between the liquid and the gas in the fluid storage reservoir, and comprising bearing surfaces on the fluid storage reservoir, where the bearing surfaces are offset from both sides of the separation surface.

Such an arrangement could be implemented in any fluid storage reservoir comprising multiple fluids.

The bearing surfaces offset from the separation surface serve to avoid swaying of the rigid diaphragm under the effect of nonuniform pressure distribution on the diaphragm, which could cause leaks between the portion containing the liquid and the portion containing the gas.

Preferably, the diaphragm is provided with sealing joints on the periphery thereof in order to provide the seal between the portion containing the gas and the portion containing the liquid.

Additionally, the bearing surfaces of the diaphragm can be provided with rolling mechanisms in order to make the movement of the diaphragm in the fluid storage reservoir easier and to accommodate the volume variations of the portion containing the liquid and the portion containing the gas.

The bearing surfaces can be continuous on the periphery of the diaphragm, be distributed discontinuously on the periphery of the diaphragm or even have for each bearing surface a single-piece surface with the reservoir varying according to the bearing surface.

Particularly advantageously, the portion containing the liquid is connected to the portion containing the gas both by a first pipe provided with a pump, with which to move the liquid in the portion containing the gas into the portion containing the liquid and also by a second pipe provided with a compressor, with which to bring the gas in the portion containing the liquid into the portion containing the gas.

This arrangement is specifically interesting in the case where the reservoir is set in the ground and has an inclination to the horizontal. Thus, in case of failure of the diaphragm leading to a leak of liquid towards the portion containing the gas and inversely a leak of gas towards the portion containing the liquid, these leaks are recovered; this works for any type of fluid storage reservoir.

The device could additionally include the following arrangements, alone or in combination:
The liquid inlet orifice is the same as the liquid outlet orifice;
The gas inlet orifice is the same as the gas outlet orifice;
The device includes a plurality of fluid storage reservoirs and includes a set of valves on the gas inlet and outlet orifices and a set of valves on the liquid inlet and outlet orifices with which to select the reservoirs into which the gas is injected and the reservoirs from which the gas is evacuated.

Advantageously, the device uses air and water which are widely available and low cost.

The outlet facility could include means for putting the gas at the pressure required by the industrial facility so as to deliver the facility the gas at a set pressure at low cost.

According to a particularly advantageous embodiment, the device is associated with means for discharging the liquid which includes a generator assembly connected to the liquid outlet orifice, where the generator assembly includes a turbine and a generator and where the evacuated liquid passes by the turbine in order to generate electric energy by the generator.

A regulation and control system for the motor assembly and a regulation and control system for the generator assembly are used to respectively control the power thereof and the pressure in the fluid storage reservoir in order to provide different operating regimes.

Thus, the device according to the invention can be used in order to store and release a compressed gas in connection with a process including the following steps:
a gas storage step comprising the following operations:
   compression of the gas in a compression facility;
   injection of the gas into the fluid storage reservoir by the gas inlet orifice;
   simultaneous with the injection of the gas, evacuation of the liquid towards a generator assembly by the liquid outlet orifice where the system for regulation and control of the generator assembly in order to evacuate the liquid keeps the pressure in the fluid storage reservoir constant;
a gas release step comprising the following operations:
   injection of liquid from the liquid source by the liquid inlet orifice into the fluid storage reservoir;
   simultaneous with the injection of the liquid, evacuation of the gas towards an outlet facility where the system for regulation and control of the motor assembly in order to inject the liquid keeps the pressure in the fluid storage reservoir constant.

With this operating regime, the gas can be stored and returned at a nearly constant pressure throughout the steps, which is particularly advantageous for producing energy but also for providing an industrial facility with gas.

The attached drawings illustrate the invention:

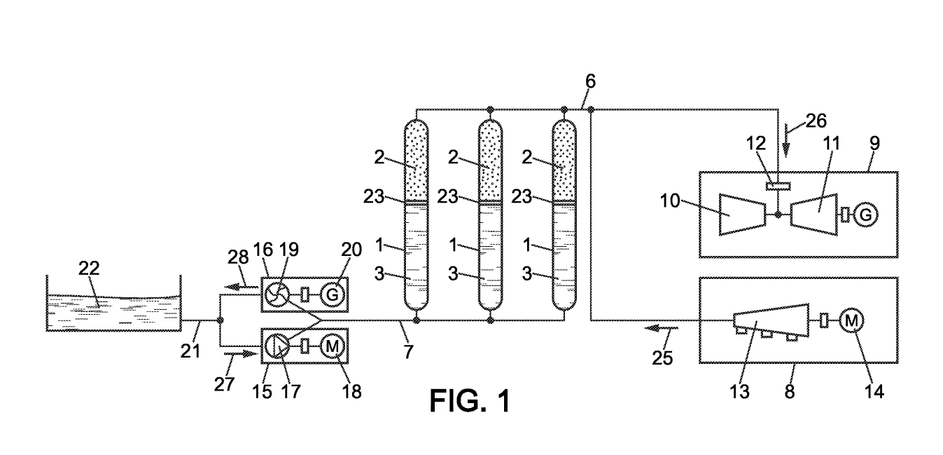

FIG. 1 shows a general drawing of an example of application of the compressed gas storage and release device according to the invention for the storage and release of electrical energy;

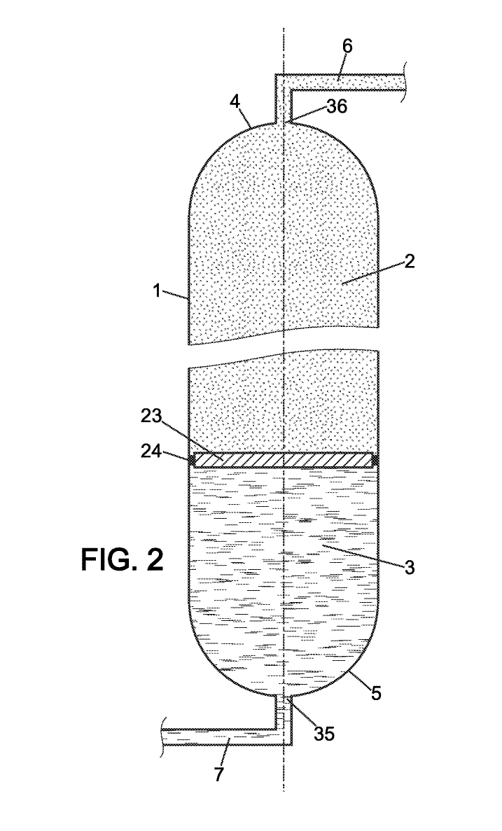

FIG. 2 shows an overall view of a fluid storage reservoir according to an example implementation of the invention;

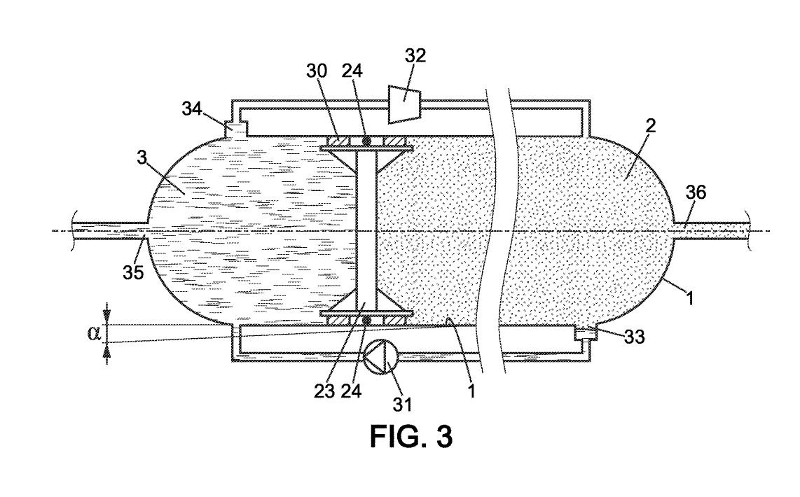

FIG. 3 shows a more detailed review of the fluid storage reservoir according to an example implementation of the invention comprising a rigid diaphragm for the gas/liquid separation;

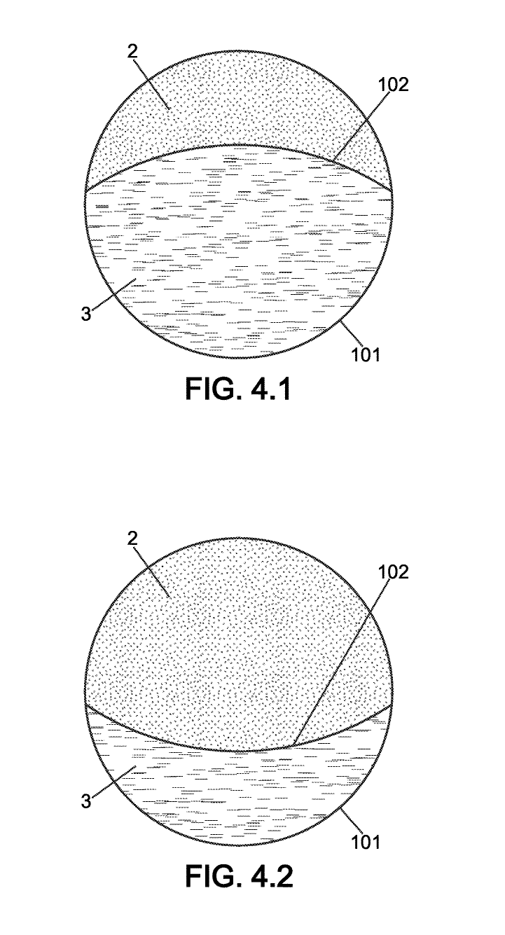

FIG. 4 is a transverse section view of another embodiment of the reservoir in which the gas/liquid separation in the storage reservoir is obtained by a deformable membrane attached to the reservoir on the entirety of the periphery thereof, where the membrane is represented in two different positions in FIGS. 4.1 and 4.2 respectively;

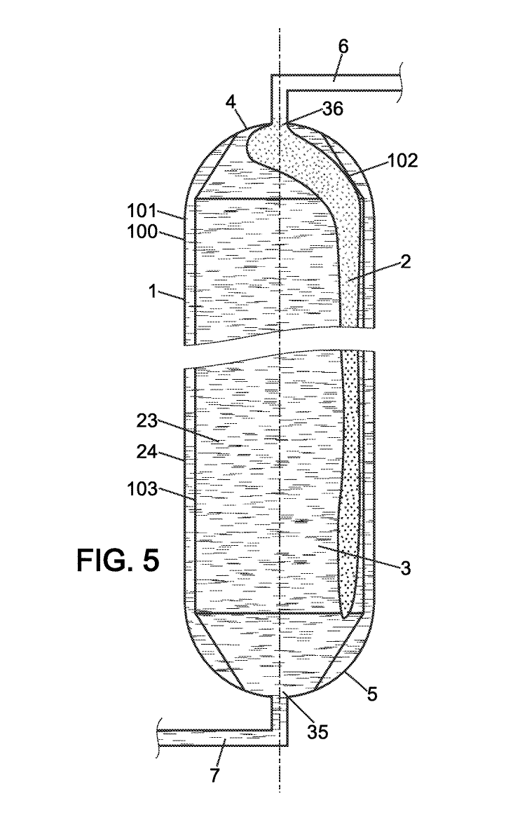

FIG. 5 shows another embodiment of the reservoir in which the gas/liquid separation in the storage reservoir is obtained by a bladder; and

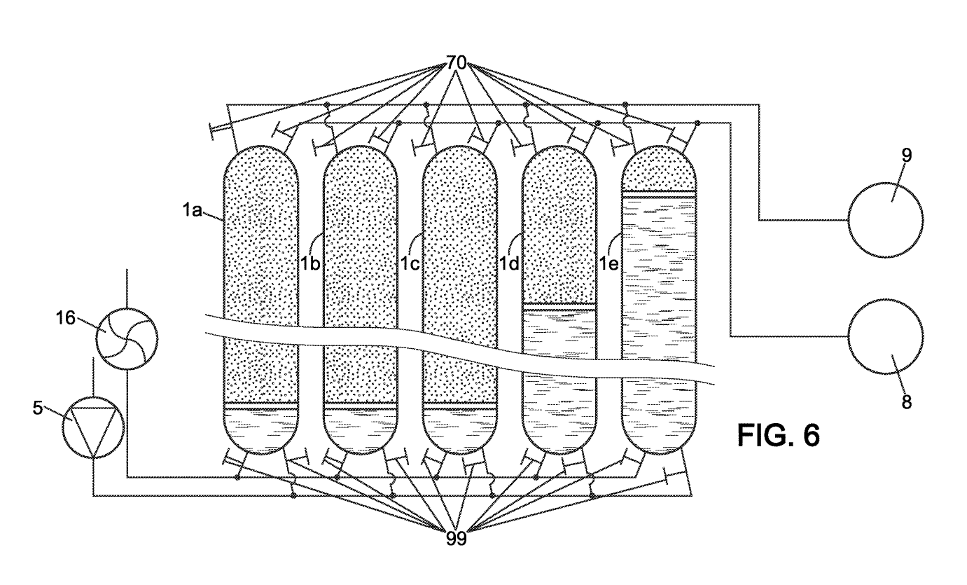

FIG. 6 shows an embodiment with several fluid storage reservoirs.

FIG. 1 shows a general drawing of a gas storage and release device according to one of the possible arrangements of the invention. In this figure, the device shown comprises three rigid fluid storage reservoirs 1 in which the pressure of the gas is kept constant because of a liquid; the number of reservoirs is matched to the required storage capacity. Advantageously, in what follows, the fluids used are air as gas and water as liquid, however with it understood that another gas and another liquid could be used.

The fluid storage reservoir 1 is shown in more detail in FIG. 2. The thickness thereof and the design thereof serve to resist the internal pressure of the fluids that it contains. The body of the fluid storage reservoir 1 can have a cylindrical shape and be provided at its ends with bottoms 4 and 5 conventionally with hemispheric or semi-elliptical shape in order to provide better strength against the strains due to the pressure of the stored fluids.

The fluid storage reservoir 1 has a cylindrical outer envelope which includes at least one metal tube, for example steel, of the type of those used for gas pipelines and oil pipelines. Such a pipe is prepared for example from a flat rolled strip by forming, such as rolling, and welding. This can also be obtained by other shaping methods.

The outer diameter of the tube forming the envelope of the reservoir is selected greater than 32 inches, which is 813 mm, whereas the length of the reservoir is selected such that the ratio of the length of the reservoir to the outer diameter thereof is advantageously greater than 8.

The selection of the outer diameter of the reservoir and the ratio of the length thereof to the diameter thereof results from technical and economic considerations. Simulations performed by considering in particular the technical constraints related to the storage, the manufacturing cost of the reservoirs and the constraints of placement on site have shown that a diameter of the reservoir greater than 32 inches and a ratio of the length thereof to the diameter thereof greater than 8 serves to produce a configuration providing an advantageous compromise for meeting the various constraints.

Here, “length” is understood to mean the longest dimension measured on the reservoir.

Here, “diameter” is understood to mean the longest dimension measured on a transverse section of the reservoir.

For example, a tube made of X80 steel with an outer diameter of 56 inches, or 1422 mm, and sized to store air at 120 bars has a wall thickness of about 40 mm; a tube of X52 steel with an outer diameter of 48 inches, or 1219 mm, and sized to store air at 80 bars has a wall thickness of about 24 mm.

The use of tubes with 48 inch and 56 inch outer diameter for manufacturing a reservoir according to the invention is already in itself particularly advantageous because it involves standard dimensions available on the market in the domain of gas pipelines and oil pipelines. Thus the manufacturing of reservoirs 1 does not require the development of new means, but simply the transformation of the tubes into reservoirs. The placement of reservoirs on site is also made easier since means already used on industrial sites for oil pipelines and gas pipelines can be reused for the reservoirs 1. Thus the manufacturing and also the installation cost of the reservoirs 1 turn out to be considerably reduced.

Depending on the applications, it can be advantageous to place several tubes end-to-end, connected by welding, in order to obtain a very long length reservoir 1, for example 50 m. This length could be increased to 100 m or 250 m according to the quantity of energy to be stored and the configuration of the storage area. The length of the reservoir is then advantageously a multiple of the longest length of the tubes for a given tube diameter and thickness.

The capacity of the fluid storage reservoir 1 can be from several tens of m³ (cubic meters) to several tens of thousands of m³ depending on the applications.

The reservoir 1 is provided with supports necessary to retain it.

The reservoir 1 is provided near a first end with at least one gas orifice 36 on the one hand connected to a gas source and on the other hand opening out into a portion of the fluid storage reservoir 1 containing the gas 2, allowing the exiting or entering flow of gas in the fluid storage reservoir. The figures show the example in which the gas orifice 36 is both a gas inlet orifice and outlet orifice for the fluid storage reservoir 1, with it understood that the gas outlet orifice can be distinct from the inlet orifice.

The gas orifice 36, as an inlet orifice, is connected by a pipe 6, resistant to the pressure of the gas 2, to at least one compression facility 8 which delivers the gas 2 under pressure to be stored when storing the gas is desired and, as an outlet orifice, to at least one outlet facility 9 which uses the pressurized gas 2 when releasing the air 2 is desired.

The compression facility 8 in FIG. 1 is made up of at least one air compressor 13 coupled to at least one electric motor 14 and serves to produce and deliver compressed air at constant pressure into the fluid storage reservoir 1 by using electrical energy. The arrow 25 in FIG. 1 shows the direction of gas flow at the outlet of the facility 8.

The outlet facility 9, is, for example, as shown in FIG. 1, a gas expansion facility and is then made up of at least one pressure regulator 10 coupled to at least one electric generator 11. Advantageously a combustion chamber 12 serves to reheat the air at the inlet of the pressure regulator 10. The gas expansion facility 9 uses compressed air at constant pressure delivered by the fluid storage reservoir 1 in order to produce electric energy. The arrow 26 on FIG. 1 shows the airflow direction at the inlet to the gas expansion facility 9.

With the device, electrical energy can be stored in the fluid storage reservoir 1 in the form of compressed gas, such as compressed air, supplied by the compression facility 8 and this electrical energy can be recovered by the expansion of the gas in the expansion facility 9.

As a variant, the outlet facility 9 directly uses the compressed gas, for example in an industrial process. In the introduction, examples of industrial domains implementing processes using compressed gas were listed.

The fluid storage reservoir 1 is provided near a second end with at least one liquid orifice 35 opening out into a portion of the fluid storage reservoir 1 containing the liquid 3 in order to allow the flow of a liquid entering and leaving the fluid storage reservoir 1.

In the figures, the orifice 35 for the liquid is both an inlet and outlet orifice for the liquid. However, the fluid storage reservoir 1 can include a liquid inlet orifice and a liquid outlet orifice which are distinct.

In order to keep the compressed gas 2 at a constant pressure in the fluid storage reservoir 1, the liquid orifice 35, as an inlet orifice, is connected by a pipe 7 resistant to the pressure of the liquid to a motor assembly 15 comprising at least one pump 17 and at least one motor 18. Means of discharge connected by the pipe 7 to the liquid outlet orifice 35 serve to evacuate the liquid from the fluid storage reservoir 1. According to an embodiment, the means of discharge comprise at least one generator assembly 16 comprising a turbine 19 coupled to at least one electric generator 20.

The arrow 27 in FIG. 1 shows the direction of the flow of the liquid through the pump 17. Upstream, the pump 17 is connected by a pipe 21 to at least one liquid reservoir 22.

The arrow 28 in FIG. 1 shows the direction of the flow of the liquid through the turbine 19. Downstream, the turbine 19 is advantageously connected by a pipe 21 to the liquid reservoir 22.

The operation of the storage device in which the gas is air and the liquid is water is now described.

During the step referred to as air storage, the air provided at an inlet pressure by the compression facility 8 enters through the air orifice 36 into the portion of the fluid storage reservoir 1 containing the air 2 and remains at a storage pressure very close to the inlet pressure. The air then exerts on the water 3 a storage pressure very close to the inlet pressure, either directly or, as will be seen later, via means for separation of the air and the water 3, for example a diaphragm 23.

Under the effect of this air pressure, the water 3 is evacuated from the lower part of the fluid storage reservoir 1 through the water orifice 35.

According to an embodiment, the water thus evacuated drives the hydraulic turbine 17 of the generator assembly 16, which serves to produce electric energy. A regulation and control system for the generator assembly 16 serves to maintain the air at a constant storage pressure throughout air storage operations.

During a step referred to as air 2 release, water 3 is pumped by the hydraulic pump 17 of the motor assembly 15 at a pressure nearly equal to the storage pressure in the fluid storage reservoir 1 and enters into the lower portion of the fluid storage reservoir 1 through the orifice 35 at a pressure very close to the storage pressure. The water then exerts a pressure on the air 2 in the fluid storage reservoir 1 very close to the storage pressure.

Under the effect of this pressure exerted by the water, the air is evacuated from the fluid reservoir 1 through the air orifice 36 and supplies the outlet facility 9 at a constant pressure very close to the storage pressure. A regulation and control system for the motor assembly 15 serves to maintain a constant gas pressure throughout the gas release operations.

FIG. 6 shows an application of the device from the invention in which several reservoirs, in this case five fluid storage reservoirs 1a to 1e are used. With this variant the volume of air stored and similarly the quantity of electric energy stored can of course be increased. In fact, the transverse dimension, for example the radius in the case of a circular section reservoir, of each of the fluid storage reservoirs 1a to 1e is limited because of the high internal pressures and in order to increase the storage capacity it can be necessary to use a set of reservoirs.

In the example shown, the fluid storage reservoirs 1a to 1e are all connected to the same air compression facility 8, to the same outlet facility 9, to the same motor assembly 15 and therefore to the same hydraulic pump 17, and to the same generator assembly 16 and therefore to the same hydraulic turbine 19. It is however possible to provide that each fluid storage reservoir 1a to 1e be connected to a compression facility 8, an outlet facility 9, a motor assembly 15 and a generator assembly 16 specific thereto.

A set of air valves 70 placed on the air inlet and outlet orifices 36 and a set of water valves 99 placed on the water inlet and outlet orifices serve to isolate certain connections. It is then possible to select certain fluid storage reservoirs 1a to 1e operating in an air storage step, meaning in which air is injected and the pressure is held constant through the control and command system for the generator assembly 16, and other reservoirs operating in an air release step, meaning in which the gas is evacuated and the pressure is held constant through the control and command system of the motor assembly 15.

The gas 2 in the fluid storage reservoir 1 is preferably separated from the liquid 3 by fluid-tight means of separation, such as a rigid and mobile diaphragm 23 separating the fluid storage reservoir 1 into a portion containing the gas 2 and a portion containing the liquid 3. The diaphragm 23 then defines a separation surface between the liquid and the gas and is mobile with changes in the gas and liquid volume during gas storage and release operations.

In fact, the means of separation must be able to move during gas storage and release operations such that the volume of the portion containing the gas decreases when the gas is released while the volume of the portion containing the liquid increases and, inversely, such that the volume of the portion containing the gas increases when gas is stored while the volume of the portion containing the liquid decreases.

The diaphragm 23 is preferably equipped with one or more sealing joints 24 on the periphery thereof in order to maintain a separation between the pressurized gas and the liquid in the fluid storage reservoir 1 and to avoid phenomena of gas dissolving in the liquid or pollution of one of the fluids by the other. Thus, the two fluids in the fluid storage reservoir 1 mutually exert a pressure on each other via the intermediary of the diaphragm 23.

The type of joint 24, especially their material, shape and sealing mechanism, is matched to the fluids 2 and 3 and to the storage conditions like pressure and temperature. It must also provide a sufficient lifetime for the joints, in particular with a good resistance to the wear resulting from rubbing on the inner surface of the reservoir resulting from the movement of the diaphragm 23 during gas storage and release operations.

In order to limit the wear of the fluid-tight separation device by rubbing against the inner wall of the reservoir, it can be advantageous to cover the wall with a coating suited for that purpose. In particular it can be an epoxy resin or PTFE, for example applied with a spray gun.

The joints 24 can be inflatable joints. In order to increase the seal between the gas and the liquid, at least two joints 24 can be used so as to form successive barriers.

In the case shown in FIG. 2, the separation surface between the air 2 and water 3 is in a horizontal plane. The air then necessarily occupies the upper portion of the fluid storage reservoir 1 and the water the lower portion of the fluid storage reservoir 1. The diaphragm 23 can then simply float on the surface of the water so as to move with the changes in the water volume. As a variant, the rigid, separation diaphragm 23 can be replaced by a membrane of deformable material separating the water and the air such that the volume of the portions containing water and gas have variable volumes changing by deformation of the membrane.

If the separation surface between the air and the water is not in a horizontal plane, it is necessary to use a rigid, separation diaphragm 23 specifically designed for the pressure differences between the side containing the liquid and the side containing the gas.

FIG. 3 thus shows a particularly advantageous variant means for separation between a gas and a liquid in the fluid storage reservoir 1 in which the separation surface between the gas and the liquid is not in a horizontal plane. For example, the separation surface is in a vertical plane or in a plane inclined a few degrees, for example between 1° and 10°, relative to the vertical plane. This can be the case if it's more advantageous that the fluid storage reservoir 1 be in a horizontal position, set on the ground, buried or when the length dimensions thereof do not allow a vertical position. It is then necessary that the design of the diaphragm 23, in the plane of the separation surface between the gas 2 and the liquid 3, be able to take up the forces due to the differences between the liquid side and gas side pressure distribution while also allowing flowing in the body of the fluid storage reservoir 1 and providing for the tightness thereof.

The rigid diaphragm 23 is therefore provided on the periphery thereof with surfaces 30 bearing on the body of the fluid storage reservoir 1, where these bearing surfaces 30 have large sizes so that they can be offset from either side of the plane of the diaphragm 23 and therefore from the surface of separation between the gas and the liquid in order to take up the moments from the applied forces. These bearing surfaces 30 are made of a material resistant to compression under the force of the pressure in the fluid storage reservoir 1 and supporting the sliding on the body of the fluid storage reservoir 1 in order to displace the diaphragm 23.

The bearing surfaces 30 can be continuous around the full circumference of the reservoir, discontinuous by being distributed equally on the circumference of the reservoir, or even discontinuous by being distributed unequally, for example with a larger total bearing surface on the lower and upper portions of the reservoir, where the pressure exerted on the diaphragm 23 by the fluids is the highest.

Similarly, the width of the bearing surfaces 30 can be constant over the circumference of the reservoir or not. In the discontinuous bearing case, the single-piece contact surface between the bearing surfaces and the reservoir can be the same for all bearings or be different depending on the bearing.

The bearings can also comprise rolling mechanisms such as for example casters serving to make the movement of the diaphragm easier.

The offset of the bearing surfaces 30 from the plane of the diaphragm 23, meaning the longest distance between a point of a bearing surface 30 and the plane of the diaphragm 23, does not have to be the same for all the bearing surfaces 30. Thus, it can be greater for the bearing surfaces 30 placed on the lower portion of the reservoir, in particular because of a higher pressure exerted by the water on the lower portion of the diaphragm 23.

The diaphragm 23 is then perfectly centered in the fluid storage reservoir 1, meaning it does not swing under the force from the pressure exerted on the two surfaces thereof, and the one or more seal joints 24 are held correctly, even when the diaphragm moves during storage and release operations.

Depending on their type, the bearing surfaces 30 can also contribute to the seal between the gas and liquid.

Thus the diaphragm 23 provided with bearing surfaces 30 serves, throughout the fluid storage reservoir 1, to provide a seal between the two fluids contained while also allowing the volume of the portion containing a first fluid and the volume containing the second fluid to vary by movement of the diaphragm 23.

In the case where the separation surface between the gas and liquid is inclined a few degrees relative to the vertical, it is advantageous to arrange the fluid storage reservoir 1 such that the lower portion 33 is the portion containing the gas and therefore that the upper portion 34 is the portion containing the liquid. Hence, in case of failure of the diaphragm 23 and or the seal joints 24 between the gas and the liquid, a possible leak of the liquid 3 towards the gas 2 through the diaphragm 23 is necessarily going to flow towards the lowest portion 33 of the fluid storage reservoir 1; this liquid can then be recovered and returned to the other side of the diaphragm 23, in the portion containing the liquid, by a low-power hydraulic pump 31. Similarly, a possible leak of the gas towards the liquid through the diaphragm 23 is necessarily going to flow towards the higher portion 34 of the fluid storage reservoir 1 in the portion containing the liquid. This gas can be returned from the other side of the diaphragm 23, into the portion containing the gas, by a low-power air compressor 32.

The lower portion 33 and the upper portion 34 of the fluid storage reservoir 1 are placed at opposite ends of the reservoir 1 so as to not impede the full movement of the diaphragm 23.

The device can be positioned in different variants and the fluid storage reservoir 1 can be on land or underwater.

The device can thus be used for storing gas intended to supply an industrial process.

By holding the pressure constant for storage of the gas and release thereof very favorable conditions for operation of the compression facility 8 and the outlet facility 9 can be provided.

Storage densities are also much higher than storage at a constant volume because of the high pressures allowed in the fluid storage reservoir 1.

It also needs be indicated that the usual pressures for using gases in industrial processes generally vary from a few bars to a few tens of bars. Storage of the gas at these relatively low pressures would have a low density resulting in high storage costs and a large space occupied.

It is therefore much more advantageous to store at high pressures.

Without an economically attractive gas storage device, industries have to produce compressed gas at the same time is its use in the industrial process. A compression facility therefore has to be sized specifically to the gas pressures required intermittently by the industrial process addressing the needs according to the steps of the process whereas this power could be greatly reduced by making the compression facility operate continuously although over a longer time. Additionally, any shutdown in the compression facility leads to the shutdown of the entire industrial mechanism which forces providing backup compression facilities.

There is therefore an additional advantage from storing the gas according to the invention when the gas is intended for an industrial process.

The arrangement from the invention therefore makes it possible to store the gas at a significant pressure and with satisfactory densities.

Additionally, it can be advantageous to use any source of pressurized gas available in the industrial processes in order to even partially supply the compression facility 8 and thus reduce the energy consumption needs of the arrangement.

In the case where another industrial process implemented on the industrial site in addition to the first should also require a limited flow rate of gas stored at a high pressure closer to that of storage of the gas, it is advantageous to place between the outlet orifice 36 for the gas from the fluid storage reservoir 1 and the gas expansion facility 9 a branch circuit with which to supply this other process in parallel with a high pressure. This branch circuit could contain a unit with which to regulate the gas to the pressure required for the process.

With the equipment according to the invention, the two industrial processes can thus be supplied simultaneously or alternately with gas at very different pressures.

In sectional view, FIG. 4 shows an implementation variant in which the means of separation include a deformable membrane 102 attached to the reservoir 101 along the entire periphery of the membrane. An example of positioning of the membrane when the reservoir contains a quantity of liquid 3 which is greater than the quantity of gas 2 is shown in view 4.1. An example of positioning of the membrane when the reservoir contains a quantity of liquid 3 which is smaller than the quantity of gas 2 is shown in view 4.2.

Here, deformable is understood to mean the capacity of the membrane 102 to be deformed elastically under the effect of the pressures exerted on the membrane 102 by the fluids in the reservoir 1.

FIG. 5 shows a variant implementation of the invention in which the means of separation include a deformable membrane 102 forming a bladder or casing. The bladder deforms under the pressure exerted by the gas and the liquid while filling and while releasing the fluid that it contains. In this example, the reservoir is positioned horizontally, the gas is inside the bladder, which is enveloped by the liquid, and buoyancy pushes the bladder into the upper part of the reservoir.

The bladder can for example be any NBR (Nitrile Butadiene Rubber), IIR (Isobutylene Isoprene Rubber), EPDM (Ethylene Propylene Diene Monomer), or NR (Natural Rubber) based elastomer. The material and thickness of the bladder are defined according to the dimensions thereof and the pressure of the fluids.

The membrane is not necessarily made from an elastomer with a high elasticity. An inelastic material can also be used. In this case, the separation membrane deploys during filling for reaching the maximum volume thereof. During emptying, the pressure exerted by the fluid located outside of the bladder returns it to the initial volume thereof.

In this figure, it can be seen an inner envelope, principally cylindrical, which keeps the bladder in a defined position in the reservoir and avoids rubbing of the membrane directly against the inner wall 100, 101 of the reservoir. Advantageously, the inner envelope 103 is porous, for example made with a perforated metal, so as to maintain contact with the liquid when the membrane is pressing on the inner envelope. This solution is applicable for a reservoir placed horizontally or vertically.

1. Device for storing and releasing fluids at nearly constant pressure, said fluids including a gas and a liquid, the device comprising an assembly of substantially identical reservoirs (1), where said reservoirs include:
a portion containing the gas and a portion containing the liquid;
a means (23) of separation between the gas and the liquid in the reservoir (1);
an inlet orifice (36) and an outlet orifice (36) for the gas opening into the portion of the reservoir (1) containing the gas;
an inlet orifice (35) and an outlet orifice (35) for the liquid opening into the portion of the reservoir (1) containing the liquid;
wherein each of the reservoirs (1) has a cylindrical outer envelope (100) made up of at least one metal tube (101) of the type of those used for gas pipelines and oil pipelines, for which:
the external diameter is more than 813 mm; and
the ratio of the length thereof to the outer diameter thereof is greater than 8.

2. Device according to claim 1, wherein the diameter of the at least one metal tube (101) is equal to 1219 mm or 1422 mm.

3. Device according to claim 1, wherein the tube (101) results from shaping and welding a flat rolled metal strip.

4. Device according to claim 1, wherein the outer cylindrical envelope (100) includes a plurality of metal tubes (101) welded end to end.

5. Device according to claim 1, wherein the means of separation comprise a deformable membrane (102).

6. Device according to claim 5, wherein the deformable membrane (102) forms a deformable bladder under the pressure in the fluid storage reservoir (1) so as to contain the gas or the liquid.

7. Device according to claim 6, wherein the reservoir (1) additionally includes an inner envelope (103) in which the deformable membrane (102) is placed.

8. Device according to claim 1, wherein the means of separation between the gas and the liquid comprise a rigid and mobile diaphragm (23) defining a separation surface between the liquid and the gas in the fluid storage reservoir (1), the diaphragm (23) comprises bearing surfaces (30) on the fluid storage reservoir (1), where the bearing surfaces (30) are offset from both sides of the separation surface.

9. Device according to claim 8, wherein the diaphragm is provided with sealing joints (24) on the periphery thereof.

10. Device according to claim 8, wherein the bearing surfaces (30) of the diaphragm (23) are provided with rolling mechanisms in order to make the movement of the diaphragm (23) in the fluid storage reservoir (1) easier.

11. Device according to claim 8, wherein the bearing surfaces (30) are continuous on the periphery of the diaphragm (23).

12. Device according to claim 8, wherein the bearing surfaces (30) are distributed discontinuously on the periphery of the diaphragm.

13. Device according to claim 12, wherein the single-piece contact surface between each bearing surface (30) and the reservoir (1) is different depending on the bearing surface (30).

14. Device according to claim 1, wherein the portion containing the liquid is connected to the portion containing the gas both by a first pipe provided with a pump, with which to move the liquid in the portion containing the gas into the portion containing the liquid and also by a second pipe provided with a compressor, with which to bring the gas in the portion containing the liquid into the portion containing the gas.

15. Device according to claim 1, wherein the liquid inlet orifice (35) is the same as the liquid outlet orifice (35).

16. Device according to claim 1, wherein the gas inlet orifice (36) is the same as the gas outlet orifice (36).

17. Device according to claim 1, comprising a plurality of fluid storage reservoirs (1a to 1e) and comprising a set of valves (70) on the gas inlet and outlet orifices (36) and a set of valves (99) on the liquid inlet and outlet orifices (35) with which to select the reservoirs (1a to 1e) into which the gas is injected and/or the reservoirs (1a to 1e) from which the gas is evacuated.

18. Device according to claim 9, wherein the bearing surfaces (30) of the diaphragm (23) are provided with rolling mechanisms in order to make the movement of the diaphragm (23) in the fluid storage reservoir (1) easier.

19. Device according to claim 9, wherein the bearing surfaces (30) are continuous on the periphery of the diaphragm (23).

20. Device according to claim 9, wherein the bearing surfaces (30) are distributed discontinuously on the periphery of the diaphragm.
